(19) United States
(12) Patent Application Publication
(10) Pub. No.: US 2026/0120642 A1
(43) Pub. Date: Apr. 30, 2026

(54) DISPLAY DEVICE AND METHOD OF DRIVING THE SAME, AND ELECTRONIC DEVICE

(71) Applicant: Samsung Display Co., Ltd., Yongin-si (KR)

(72) Inventors: Jun Ki HONG, Yongin-si (KR); Min PARK, Yongin-si (KR); Jae Hoon LEE, Yongin-si (KR)

(21) Appl. No.: 19/270,212

(22) Filed: Jul. 15, 2025

(30) Foreign Application Priority Data
Oct. 31, 2024 (KR) 10-2024-0152587

(51) Int. Cl. G09G 3/3258; G09G 3/32

(52) U.S. Cl. CPC G09G 3/3258; G09G 3/32; G09G 2300/0842; G09G 2320/0276; G09G 2320/045; G09G 2330/021

(57) ABSTRACT

A display device includes: a battery; a voltage generator configured to generate a first driving power source, corresponding to an input power source supplied from the battery; and pixels connected to scan lines and data lines, wherein the pixels include: a first pixel configured to emit light of a first color, corresponding to the first driving power source; and a second pixel configured to emit light of a second color, corresponding to a second driving power source supplied from the battery.

### CROSS-REFERENCE TO RELATED APPLICATION

The present application claims priority to and the benefit of Korean Patent Application No. 10-2024-0152587, filed on Oct. 31, 2024, in the Korean Intellectual Property Office, the entire disclosure of which is incorporated herein by reference.

### BACKGROUND

### 1. Field

Aspects of some embodiments of the present disclosure generally relate to a display device and a method of driving the same, and an electronic device.

### 2. Description of the Related Art

A display device may include a display panel for displaying an image. The display panel may include pixels, and a light emitting element included in each of the pixels may emit light with a luminance corresponding to an amount of driving current.

The pixels may include light emitting elements emitting light of different colors, and a threshold voltage of each of the light emitting elements may be differently set corresponding to a forming material. Therefore, a method capable of reducing power consumption by considering threshold voltages of light emitting elements is required.

The above information disclosed in this Background section is only for enhancement of understanding of the background and therefore the information discussed in this Background section does not necessarily constitute prior art.

### SUMMARY

Aspects of some embodiments include a display device and a method of driving the same, and an electronic device, which can relatively reduce power consumption.

According to some embodiments of the present disclosure, a display device includes: a battery; a voltage generator configured to generate a first driving power source, corresponding to an input power source supplied from the battery; and pixels connected to scan lines and data lines, wherein the pixels include: a first pixel emitting light of a first color, corresponding to the first driving power source; and a second pixel emitting light of a second color, corresponding to a second driving power source supplied from the battery.

According to some embodiments, the second driving power source and the input power source may have a same power source.

According to some embodiments, the second driving power source may have a relatively low voltage as compared with the first driving power source.

According to some embodiments, the first color may be blue and the second color may be red.

According to some embodiments, the pixels may further include a third pixel emitting light of a third color, corresponding to the second driving power source.

According to some embodiments, the third color may be green.

According to some embodiments, the display device may further include: a scan driver configured to drive the scan lines; a data driver configured to drive the data lines; and a timing controller configured to control the scan driver and the data driver.

According to some embodiments, each of the pixels may include: a light emitting element emitting light of the first color or the second color; and a driving transistor configured to supply a driving current to the light emitting element from the first driving power source or the second driving power source.

According to some embodiments, the driving transistor may be a P-type transistor.

According to some embodiments, the timing controller my include: a correction value generator configured to receive the second driving power source, and generate a correction value, corresponding to the voltage of the second driving power source; and an output data generator configured to generate corrected output data by reflecting the correction value on input data.

According to some embodiments, the corrected output data may correspond to the second pixel.

According to some embodiments, the display device may further include: a reference voltage generator configured to receive the second driving power source, and generate a first gamma reference voltage and a second reference voltage; and a gamma voltage generator configured to generate first gamma voltages corresponding to the first pixel and second gamma voltages corresponding to the second pixel, corresponding to the first gamma reference voltage and the second gamma reference voltage. According to some embodiments, the second gamma reference voltage may be controlled corresponding to the voltage of the second driving power source.

According to some embodiments, the gamma voltage generator may include: a first gamma voltage generator configured to generate the first gamma voltages, corresponding to the first gamma reference voltage; and a second gamma voltage generator configured to generate the second gamma voltages, corresponding to the second gamma reference voltage.

According to some embodiments of the present disclosure, in a method of driving a display device, the method includes: allowing first pixels to emit light of a first color, corresponding to a driving current supplied from a first driving power source; and allowing second pixels to emit light of a second color, corresponding to a driving current supplied from a second driving power source, wherein the first color is blue, the second color is red, and the second driving power source has a relatively low voltage as compared with the first driving power source.

According to some embodiments, the method may further include: generating the first driving power source by boosting an input voltage supplied from a battery; and supplying the first driving power source to the first pixels.

According to some embodiments, the first driving power source may be supplied to the second pixels from the battery.

According to some embodiments, the first driving power source may be the input voltage.

According to some embodiments, the method may further include: generating a correction value, corresponding to the voltage of the second driving power source; and generating output data by reflecting the correction value on input data to be supplied to the second pixels.

According to some embodiments, the correction value may be set such that light with a luminance corresponding to a grayscale is generated in the second pixels, corresponding to the voltage of the second driving power source.

According to some embodiments, the method may further include: controlling gamma voltages, corresponding to the second driving power source; and generating a data signal to be supplied to the second pixels, using the gamma voltages.

According to some embodiments of the present disclosure, an electronic device includes: a main processor; a controller configured to receive an image signal from the main processor, and output image data by converting a data format of the image signal; a memory configured to store data processed from the main processor; a battery; a voltage generator configured to generate a first driving power source, corresponding to an input power source supplied from the battery; and a display panel including pixels connected to scan lines and data lines, wherein the pixels include: a first pixel emitting light of a first color, corresponding to the first driving power source; and a second pixel emitting light of a second color, corresponding to a second driving power source which is supplied from the battery and has a relatively low voltage as compared with the first driving power source.

### BRIEF DESCRIPTION OF THE DRAWINGS

Aspects of some embodiments of the present disclosure will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that in case that an element is referred to as being “between” two elements, it can be the only element between the two elements, or one or more intervening elements may also be present. Like reference numerals refer to like elements throughout.

FIG. 1 is a diagram illustrating a display device according to some embodiments of the present disclosure.

FIG. 2 is a diagram illustrating a pixel according to some embodiments of the present disclosure.

FIG. 3 is a diagram illustrating a pixel according to some embodiments of the present disclosure.

FIG. 4 is a diagram illustrating a display device according to some embodiments of the present disclosure.

FIG. 5 is a diagram illustrating aspects of a timing controller shown in FIG. 4.

FIG. 6 is a diagram illustrating a gamma generator according to some embodiments of the present disclosure.

FIG. 7 is a diagram illustrating an electronic device according to some embodiments of the present disclosure.

FIGS. 8 to 11 are views illustrating electronic devices according to some embodiments of the present disclosure.

### DETAILED DESCRIPTION

Hereinafter, aspects of some embodiments are described in more detail with reference to the accompanying drawings so that those skilled in the art may relatively easily practice the disclosure. Embodiments according to the present disclosure may be implemented in various different forms and is not limited to the disclosed embodiments described in the specification.

A part irrelevant to the description will be omitted to clearly describe the disclosure, and the same or similar constituent elements will be designated by the same reference numerals throughout the specification. Therefore, the same reference numerals may be used in different drawings to identify the same or similar elements.

In description, the expression “equal” may mean “substantially equal.” That is, this may mean equality to a degree to which those skilled in the art can understand the equality. Other expressions may be expressions in which “substantially” is omitted.

Some embodiments are described in the accompanying drawings in relation to functional blocks, units, and/or modules. Those skilled in the art will understand that these blocks, units, and/or modules are physically implemented by logic circuits, individual components, microprocessors, hard wire circuits, memory elements, line connection, and other electronic circuits. This may be formed by using semiconductor-based manufacturing techniques or other manufacturing techniques. In the case of blocks, units, and/or modules implemented by microprocessors or other similar hardware, the units, and/or modules are programmed and controlled by using software, to perform various functions discussed in the disclosure, and may be selectively driven by firmware and/or software. In addition, each block, each unit, and/or each module may be implemented by dedicated hardware or by a combination dedicated hardware to perform some functions of the block, the unit, and/or the module and a processor (e.g., one or more programmed microprocessors and associated circuitry) to perform other functions of the block, the unit, and/or the module. In some embodiments, the blocks, the units, and/or the modules may be physically separated into two or more individual blocks, two or more individual units, and/or two or more individual modules without departing from the scope of embodiments according to the present disclosure. Also, in some embodiments, the blocks, the units, and/or the modules may be physically separated into more complex blocks, more complex units, and/or more complex modules without departing from the scope of the present disclosure.

The term “connection” between two components may include both electrical connection and physical connection, but embodiments according to the present disclosure are not necessarily limited thereto. For example, the term “connection” used based on circuit diagrams may mean electrical connection, and the term “connection” used based on sectional and plan views may mean physical connection.

It will be understood that, although the terms “first,” “second,” etc. may be used herein to describe various elements, these elements should not be limited by these terms. These terms are only used to distinguish one element from another element. Thus, a “first” element discussed below could also be termed a “second” element without departing from the teachings of the disclosure.

Embodiments according to the present disclosure is not limited to embodiments disclosed below, and may be implemented in various forms. Each embodiment disclosed below may be independently embodied or be combined with at least another embodiment prior to being embodied.

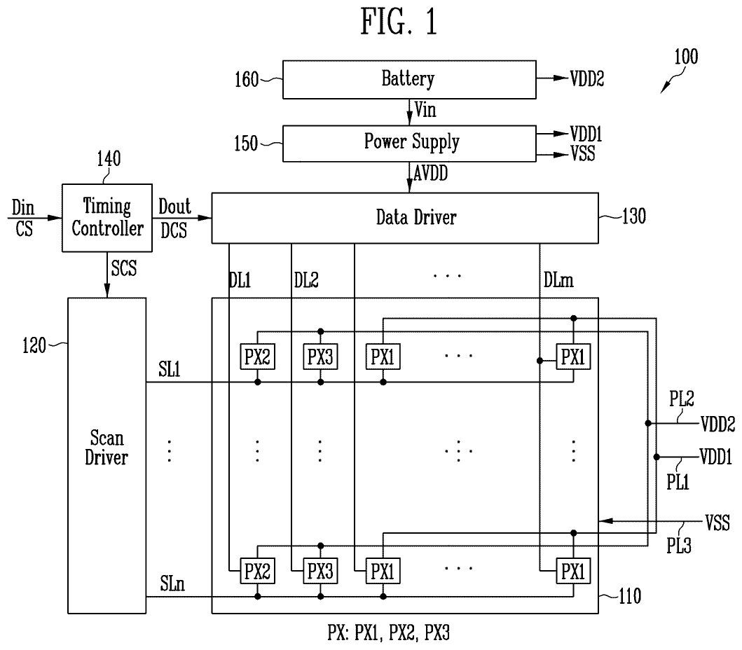

FIG. 1 is a diagram illustrating a display device according to some embodiments of the present disclosure.

Referring to FIG. 1, a display device 100 according to some embodiments of the present disclosure may include a display unit 110 (or display panel), a scan driver 120, a data driver 130, a timing controller 140, a power supply 150, and a battery 160.

The display unit 110 may include pixels PX connected to scan lines SL1 to SLn, data lines DL1, DL2, . . . , and DLm, and power lines PL1, PL2, and PL3 (n and m are natural numbers of 3 or more).

The pixels PX may include a first pixel PX1, a second pixel PX2, and a third pixel PX3. The first pixel PX1 may include a first light emitting element emitting light of a first color. The first pixel PX1 may emit light of the first color with a luminance corresponding to a data signal. The second pixel PX2 may include a second light emitting element emitting light of a second color. The second pixel PX2 may emit light of the second color with a luminance corresponding to a data signal. The third pixel PX3 may include a third light emitting element emitting light of a third color. The third pixel PX3 may emit light of the third color with a luminance corresponding to a data signal.

The first color may be a color different from the second color and the third color. According to some embodiments, the first color may be blue. According to some embodiments, the second color may be a color different from the third color. According to some embodiments, the second color may be red. According to some embodiments, the third color may be green.

The first pixel PX1 may be electrically connected to a first power line PL1 and a third power line PL3. The first power line PL1 may be supplied with a first driving power source VDD1 from the power supply 150, and the third power line PL3 may be supplied with a third driving power source VSS from the power supply 150. In case that the first pixel PX1 emits light, the first driving power source VDD1 may be set to a voltage higher than a voltage of the third driving power source VSS. The first pixel PX1 may be supplied with a data signal from a data line (any one of DL1 to DLm) connected thereto in case that an enable scan signal is supplied to a scan line (any one of SL1 to SLn) connected thereto. The first pixel PX1 supplied with the data signal may control an amount of driving current flowing from the first driving power source VDD1 to the third driving power source VSS via the first light emitting element, corresponding to a voltage of the data signal. Accordingly, the first pixel PX1 may emit light of the first color with a luminance corresponding to the data signal.

The second pixel PX2 may be electrically connected to a second power line PL2 and the third power line PL3. The second power line PL2 may be supplied with a second driving power source VDD2 from the battery 160, and the third power line PL3 may be supplied with the third driving power source VSS from the power supply 150. In case that the second pixel PX2 emits light, the second driving power source VDD2 may be set to a voltage higher than the voltage of the third driving power source VSS. The second pixel PX2 may be supplied with a data signal from a data line (any one of DL1 to DLm) connected thereto in case that an enable scan signal is supplied to a scan line (any one of SL1 to SLn) connected thereto. The second pixel PX2 supplied with the data signal may control an amount of driving current flowing from the second driving power source VDD2 to the third driving power source VSS via the second light emitting element, corresponding to a voltage of the data signal. Accordingly, the second pixel PX2 may emit light of the second color with a luminance corresponding to the data signal.

The third pixel PX3 may be electrically connected to the second power line PL2 and the third power line PL3. The third pixel PX3 may be supplied with a data signal from a data line (any one of DL1 to DLm) connected thereto in case that an enable scan signal is supplied to a scan line (any one of SL1 to SLn) connected thereto. The third pixel PX3 supplied with the data signal may control an amount of driving current flowing from the second driving power source VDD2 to the third driving power source VSS via the third light emitting element, corresponding to a voltage of the data signal. Accordingly, the third pixel PX3 may emit light of the third color with a luminance corresponding to the data signal.

The second driving power source VDD2 may have a relatively low voltage as compared with the first driving power source VDD1. According to some embodiments of the present disclosure, the second driving power source VDD2 supplied to the second pixel PX2 and the third pixel PX3 may have a voltage lower than the voltage of the first driving power source VDD1 supplied to the first pixel PX1. In case that a driving power source having a relatively low voltage is supplied to the second pixel PX2 and the third pixel PX3 as compared with the first pixel PX1, the power consumption of the display device 100 may be relatively reduced.

For example, the first light emitting element may have a relatively high threshold voltage as compared with the second light emitting element and the third light emitting element. Therefore, in case that a same driving power source is supplied to the first pixel PX1 to the third pixel PX3, a voltage of the driving power source is to be determined based on the first light emitting element. A driving power source having a voltage higher than a voltage required to drive the second pixel PX2 and the third pixel PX3 may be supplied to the second pixel PX2 and the third pixel PX3, and accordingly, the power consumption of the display device 100 may be increased.

According to some embodiments of the present disclosure, the first driving power source VDD1 corresponding to a threshold voltage of the first light emitting element may be supplied to the first pixel, and the second driving power source VDD2 having a voltage lower than the voltage of the first driving power source VDD1 may be supplied to the second pixel PX2 and the third pixel PX3, corresponding to threshold voltages of the second light emitting element and the third light emitting element. Power consumed in the second pixel PX2 and the third pixel PX3 may be relatively reduced.

The timing controller 140 may receive input data Din and control signals CS from a host system through an interface. According to some embodiments, the timing controller 140 may receive the input data Din and the control signals CS from at least one of a Graphics Processing Unit (GPU), a Central Processing Unit (CPU), or an Application Processor (AP), which are included in the host system. Various signals including a clock signal may be included in the control signals CS.

The timing controller 140 may generate a scan driving signal SCS and a data driving signal DCS, based on the control signals. The scan driving signal SCS and the data driving signal DCS may be supplied to the scan driver 120 and the data driver 130, respectively.

The timing controller 140 may realign the input data Din to be suitable for specifications of the display device 100. Also, the timing controller 140 may generate output data Dout by correcting the input data Din, and supply the output data Dout to the data driver 130. According to some embodiments, the timing controller 140 may correct the input data Din, corresponding to an optical measurement result measured in a processing process, thereby generating the output data Dout.

The scan driver 120 may receive the scan driving signal SCS from the timing controller 140. At least one scan start signal and clock signals, which are necessary for driving of the scan driver 120, may be included in the scan driving signal SCS. The scan driver 120 may generate an enable scan signal while shifting the scan start signal, corresponding to a clock signal. The enable scan signal may be set to a gate-on voltage such that transistors included in the pixels PX can be turned on. According to some embodiments, in case that the enable scan signal is supplied to an N-type transistor, the enable scan signal may be set to a logic high level voltage. According to some embodiments, in case that the enable scan signal is supplied to a P-type transistor, the enable scan signal may be set to a logic low level voltage.

The data driver 130 may receive the output data Dout and the data driving signal DCS from the timing controller 140. Also, the data driver 130 may be supplied with an analog driving power source AVDD from the power supply 150. The data driver 130 supplied with the analog driving power source AVDD may generate gamma voltages corresponding grayscales.

A sampling signal and/or timing signals, necessary for driving the data driver 130, may be included in the data driving signal DCS. The data driver 130 may generate a data signal, using grayscales of the output data and gamma voltages. The data driver 130 may supply the data signal to the data lines DL1 to DLm in a horizontal period unit.

The power supply 150 may receive a voltage of an input power source Vin from the battery 160, and generate various power sources necessary for driving of the display device 100, using the input power source Vin. According to some embodiments, the power supply 150 may generate the first driving power source VDD1 by boosting the voltage of the input power source Vin, and supply the voltage of the first driving power source VDD1 to the first pixel PX1 via the first power line PL1. According to some embodiments, the input power source Vin may be set to 3.7 V (or about 3.7 V), and the first driving power source VDD1 may be set to 4.6 V. The first power line PL1 may be commonly connected to all first pixels PX1 included in the display unit 110.

According to some embodiments, the power supply 150 may generate the third driving power source VSS, using the input power source Vin, and supply the voltage of the third driving power source VSS to the pixels PX via the third power line PL3. The third power line PL3 may be commonly connected to all the pixels PX included in the display unit 110.

The first driving power source VDD1 generated by the power supply 150 may be supplied to only the first pixels PX1. Power consumed to generate the first driving power source VDD1 in the power supply 150 may be decreased by a certain percent (e.g., 12% or about 12%) as compared with a case where the first driving power source VDD1 is supplied to all the pixels PX.

The battery 160 may supply the voltage of the input power source Vin to the power supply 150. Also, the battery 160 may supply the voltage of the second driving power source VDD2 to the second pixel PX2 and the third pixel PX3 via the second power line PL2. The second power line PL2 may be commonly connected to all second pixels PX2 and all third pixels PX3, which are included in the display unit 110. The second driving power source VDD2 and the input power source Vin may be a same power source.

According to some embodiments of the present disclosure, the second driving power source VDD2 supplied to the second pixel PX2 and the third pixel PX3 may be directly supplied to the second power line PL2 from the battery 160 without going through a separate boosting process, and accordingly, the power consumption of the display device 100 may be relatively reduced. In addition, the second driving power source VDD2 may be set to a relatively low voltage as compared with the first driving power source VDD1, and accordingly, the power consumption of the display device 100 may be relatively reduced.

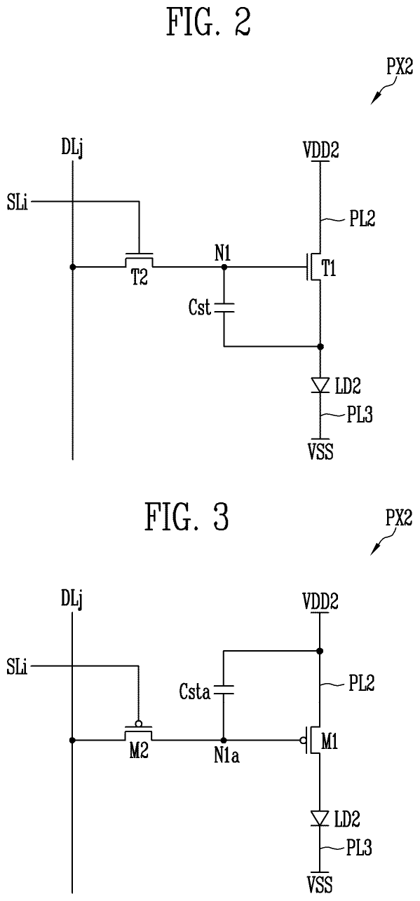

FIG. 2 is a diagram illustrating a pixel according to some embodiments of the present disclosure. The embodiments of the present disclosure are not limited to the pixel shown in FIG. 2, and may have various circuit configurations. For example, according to some embodiments, the pixel may include additional components without departing from the spirit and scope of embodiments according to the present disclosure. In FIG. 2, for convenience of description, the second pixel PX2 is illustrated, and the first pixel PX1 and the third pixel PX3 may be have circuit configurations identical (or substantially identical) to the circuit configuration of the second pixel PX2.

Referring to FIG. 2, a pixel PX2 (or second pixel) according to some embodiments of the present disclosure may include a plurality of transistors T1 and T2, a storage capacitor Cst, and a light emitting element LD2 (or second light emitting element).

A first electrode (or anode electrode) of the light emitting element LD2 may be connected to a second electrode of a first transistor T1, and a second electrode (or cathode electrode) of the light emitting element LD2 may be connected to the third power line PL3. The light emitting element LD2 may emit light of the second color with a luminance corresponding to an amount of current supplied from the first transistor T1.

The light emitting element LD2 may be configured as an organic light emitting diode, or be configured as an inorganic light emitting diode such as a micro LED (light emitting diode) or a quantum dot light emitting diode. Also, the light emitting element LD2 may be an element configured with a combination of an organic material and an inorganic material. Although only one light emitting element LD2 is illustrated, a plurality of sub-light emitting elements may be connected in series, parallel or series/parallel to each other, to substitute for the light emitting element LD2.

A first electrode of the first transistor T1 (or driving transistor) may be connected to the second power line PL2, and the second electrode of the first transistor T1 may be connected to the first electrode of the light emitting element LD2. In addition, a gate electrode of the first transistor T1 may be connected to a first node N1. The first transistor T1 may control an amount of current supplied from the second driving power source VDD2 to the third driving power source VSS via the light emitting element LD2, corresponding to a voltage of the first node N1.

A first electrode of a second transistor T2 may be connected to a data line DLj, and a second electrode of the second transistor T2 may be connected to the first node N1. In addition, a gate electrode of the second transistor T2 may be connected to a scan line SLi. The second transistor T2 may be turned on in case that an enable scan signal is supplied to the scan line SLi, to electrically connect the data line DLj and the first node N1 to each other. In case that the data line DLj and the first node N1 are electrically connected to each other, a data signal from the data line DLj may be supplied to the first node N1.

The storage capacitor Cst may be connected between the first node N1 and the first electrode of the light emitting element LD2. The storage capacitor Cst may store the voltage of the first node N1 (or a voltage of the data signal).

In some embodiments, the first transistor T1 may be an N-type transistor. In case that the first transistor T1 is the N-type transistor, a voltage stored in the storage capacitor Cst may be determined by the voltage of the data signal and a voltage of the first electrode of the light emitting element LD2. For example, the second driving power source VDD2 may have no influence on a Vgs voltage of the first transistor T1. Therefore, in case that the first transistor T1 is the N-type transistor, the voltage of the data signal may be set regardless of the second driving power source VDD2.

FIG. 3 is a diagram illustrating a pixel according to some embodiments of the present disclosure. The embodiments of the present disclosure are not limited to the pixel shown in FIG. 3, and may have various circuit configurations. For example, according to various embodiments, the pixel may include additional components without departing from the spirit and scope of embodiments according to the present disclosure. In FIG. 3, for convenience of description, the second pixel PX2 is illustrated, and the first pixel PX1 and the third pixel PX3 may be have circuit configurations identical (or substantially identical) to the circuit configuration of the second pixel PX2.

Referring to FIG. 3, a pixel PX2 (or second pixel) according to some embodiments of the present disclosure may include a plurality of transistors M1 and M2, a storage capacitor Csta, and a light emitting element LD2 (or second light emitting element).

A first electrode (or anode electrode) of the light emitting element LD2 may be connected to a second electrode of a first transistor M1, and a second electrode (or cathode electrode) of the light emitting element LD2 may be connected to the third power line PL3. The light emitting element LD2 may emit light of the second color with a luminance corresponding to an amount of current supplied from the first transistor M1.

The light emitting element LD2 may be configured as an organic light emitting diode, or be configured as an inorganic light emitting diode such as a micro LED (light emitting diode) or a quantum dot light emitting diode. Also, the light emitting element LD2 may be an element configured with a combination of an organic material and an inorganic material. Although only one light emitting element LD2 is illustrated, a plurality of sub-light emitting elements may be connected in series, parallel or series/parallel to each other, to substitute for the light emitting element LD2.

A first electrode of the first transistor M1 (or driving transistor) may be connected to the second power line PL2, and the second electrode of the first transistor M1 may be connected to the first electrode of the light emitting element LD2. In addition, a gate electrode of the first transistor M1 may be connected to a first node N1a. The first transistor M1 may control an amount of current supplied from the second driving power source VDD2 to the third driving power source VSS via the light emitting element LD2, corresponding to a voltage of the first node N1a.

A first electrode of a second transistor M2 may be connected to a data line DLj, and a second electrode of the second transistor M2 may be connected to the first node N1a. In addition, a gate electrode of the second transistor M2 may be connected to a scan line SLi. The second transistor M2 may be turned on in case that an enable scan signal is supplied, to electrically connect the data line DLj and the first node N1a to each other. In case that the data line DLj and the first node N1a are electrically connected to each other, a data signal from the data line DLj may be supplied to the first node N1a.

The storage capacitor Csta may be connected between the first node N1a and the second power line PL2. The storage capacitor Csta may store the voltage of the first node N1a (or a voltage of the data signal).

In some embodiments, the first transistor M1 may be a P-type transistor. In case that the first transistor M1 is the P-type transistor, a voltage stored in the storage capacitor Csta may be determined by the voltage of the data signal and the second driving power source VDD2. For example, the voltage stored in the storage capacitor Csta (i.e., a Vgs voltage of the first transistor M1) may be influenced by the voltage of the second driving power source VDD2.

The voltage of the data signal may be set corresponding to the voltage of the second driving power source VDD2. The voltage of the data signal may be set such that a grayscale can be implemented in the pixel PX2, corresponding to the second driving power source VDD2.

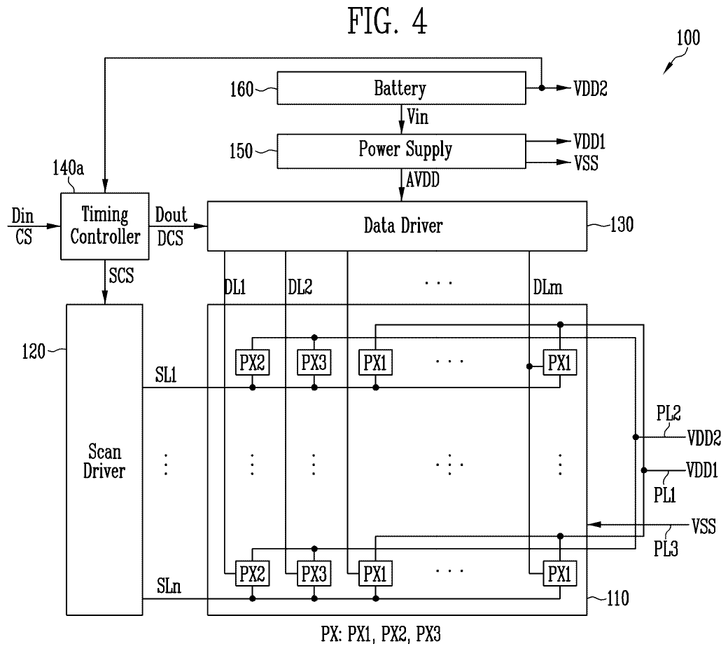

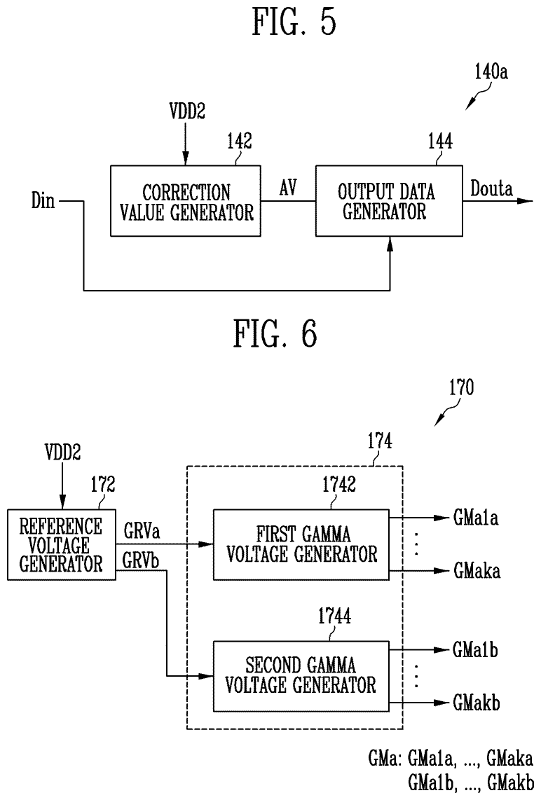

FIG. 4 is a diagram illustrating a display device according to some embodiments of the present disclosure. In FIG. 4, components identical to the components shown in FIG. 1 are designated by liker reference numerals, and overlapping descriptions will be omitted. FIG. 5 is a diagram illustrating aspects of a timing controller shown in FIG. 4. In FIG. 5, only components necessary for description of the disclosure among components of a timing controller 140a will be illustrated.

Referring to FIGS. 4 and 5, a display device 100 according to some embodiments of the present disclosure includes a display unit 110 (or display panel), a scan driver 120, a data driver 130, a timing controller 140a, a power supply 150, and a battery 160.

The timing controller 140a may be supplied with a second driving power source VDD2 from the battery 160. The timing controller 140a supplied with the second driving power source VDD2 may generate output data Dout by correcting input data Din, corresponding to a voltage of the second driving power source VDD2. In an example, the timing controller 140a may generate the output data Dout by correcting the input data Din such that a desired grayscale can be implemented in each of a second pixel PX2 and a third pixel PX3, corresponding to the voltage of the second driving power source VDD2.

To this end, the timing controller 140a may include a correction value generator 142 and an output data generator 144.

The correction value generator 142 may be supplied with the second driving power source VDD2. The correction value generator 142 may generate a correction value AV corresponding to each of the second pixel PX2 and the third pixel PX3, corresponding to the voltage of the second driving power source VDD2. The correction value AV may vary for each grayscale, or have a same value regardless of grayscales. The correction value AV may be experimentally determined such that a desired grayscale can be implemented in each of the second pixel PX2 and the third pixel PX3, which are supplied with the second driving power source VDD2.

The output data generator 144 may generate corrected output data Douta by reflecting a same correction value AV or different correction values AV on each of input data Din corresponding to the second pixel PX2 and the third pixel PX3. The corrected output data Douta may be included in output data Dout to be supplied to the data driver 130. The data driver 130 may generate a data signal supplied to each of the second pixel PX2 and the third pixel PX3, corresponding to the corrected output data Douta, and accordingly, light with a luminance corresponding to a desired grayscale may be emitted from each of the second pixel PX2 and the third pixel PX3.

As described above, according to some embodiments of the present disclosure, in case that a driving transistor included in each of the second pixel PX2 and the third pixel PX3 is a P-type transistor, the input data Din may be corrected such that a desired grayscale can be implemented corresponding to the second driving power source VDD2.

Additionally, a voltage of a data signal to be supplied to each of the second pixel PX2 and the third pixel PX3, corresponding to the voltage of the second driving power source VDD2, may be set or predetermined before the display device 100 is released. The correction value generator 142 and the output data generator 144 may be excluded.

FIG. 6 is a diagram illustrating a gamma generator according to some embodiments of the present disclosure. According to some embodiments of the present disclosure, a gamma generator 170 may be included in at least one component among the timing controller 140, the data driver 130, and/or the power supply 150. However, the embodiments of the present disclosure are not limited thereto, and the gamma generator 170 may be formed as a separate component in the display device 100.

Referring to FIG. 6, the gamma generator according to some embodiments of the present disclosure may include a reference voltage generator 172 and a gamma voltage generator 174.

The reference voltage generator 172 may generate a gamma reference voltage GRVa and GRVb. According to some embodiments, the reference voltage generator 172 may generate the gamma reference voltage GRVa and GRVb, using the analog driving power source AVDD.

The gamma reference voltage GRVa and GRVb may include a first gamma reference voltage GRVa corresponding to the first pixel PX1 and a second gamma reference voltage GRVb corresponding to the second pixel PX2. According to some embodiments, a third gamma reference voltage corresponding to the third pixel PX3 may be additionally included.

The reference voltage generator 172 may generate the first gamma reference voltage GRVa having a voltage that is set or predetermined regardless of the second driving power source VDD2. The reference voltage generator 172 may generate the second gamma reference voltage GRVb with reference to the voltage of the second driving power source VDD2. A voltage value of the second gamma reference voltage GRVb may be set such that light with a luminance corresponding to a grayscale can be generated in the second pixel PX2 supplied with the second driving power source VDD2. Additionally, the reference voltage generator 172 may generate the third gamma reference voltage with reference to the voltage of the second driving power source VDD2.

The gamma voltage generator 174 may include a first gamma voltage generator 1742 and a second gamma voltage generator 1744.

The first gamma voltage generator 1742 may generate first gamma voltages GMa1a to GMaka (k is a natural number of 2 or more) respectively corresponding to grayscales, using the first gamma reference voltage GRVa. The data driver 130 may generate a data signal to be supplied to the first pixel PX1, using the first gamma voltages GMa1a to GMaka.

The second gamma voltage generator 1744 may generate second gamma voltages GMa1b to GMakb respectively corresponding to grayscales, using the second gamma reference voltage GRVb. The data driver 130 may generate a data signal to be supplied to the second pixel PX2, using the second gamma voltages GMa1b to GMakb. The second gamma voltages GMa1b to GMakb may have a voltage corresponding to the voltage of the second driving power source VDD2, and accordingly, light with a luminance corresponding to each of the grayscales may be generated in the second pixel PX2.

The gamma voltage generator 174 may additionally include a component for generating third gamma voltages to be supplied to the third pixel PX3.

As described above, according to some embodiments of the present disclosure, in case that the driving transistor included in each of the second pixel PX2 and the third pixel PX3 is a P-type transistor, a gamma voltage may be generated such that a desired grayscale can be implemented corresponding to the second driving power source VDD2.

Additionally, a gamma voltage to be supplied to each of the second pixel PX2 and the third pixel PX3, corresponding to the voltage of the second driving power source VDD2, may be set or predetermined before the display device 100 is released.

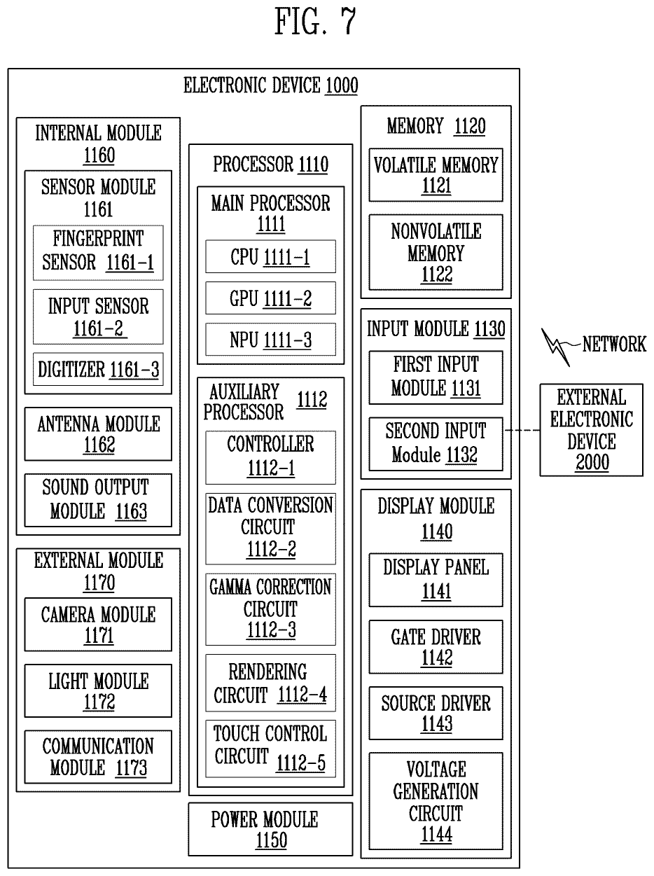

FIG. 7 is a diagram illustrating an electronic device according to some embodiments of the present disclosure.

Referring to FIG. 7, an electronic device 1000 according to some embodiments of the present disclosure may output various information through a display module 1140. In case that a processor 1110 executes an application stored in a memory 1120, the display module 1140 may provide application information to a user through a display panel 1141.

The processor 1110 may acquire an external input through an input module 1130 or a sensor module 1161, and execute an application corresponding to the external input. For example, in case that the user selects a camera icon (or camera application icon) displayed on the display panel 1141, the processor 1110 may acquire a user input through an input sensor 1161-2, and activate a camera module 1171. The processor 1110 may transfer, to the display module 1140, image data corresponding to a photographed image acquired through the camera module 1171. The display module 1140 may display an image corresponding to the photographed image through the display panel 1141.

According to some embodiments, in case that personal information authentication is executed in the display module 1140, a fingerprint sensor 1161-1 may acquire input fingerprint information as input data. The processor 1110 may compare the input data acquired through the fingerprint sensor 1161-1 with authentication data stored in the memory 1120, and execute an application according to a comparison result. The display module 1140 may display information executed according to a logic of the application through the display panel 1141. The fingerprint sensor 1161-1 may be located to acquire fingerprint information in the entire area of the display panel 1141.

According to some embodiments, in case that a music streaming icon displayed on the display module 1140 is selected, the processor 1110 may acquire a user input through the input sensor 1161-2, and active a music streaming application stored in the memory 1120. In case that a music play command is input in the music streaming application, the processor 1110 may activate a sound output module 1163, thereby providing the user with sound information which accords with the music play command.

In the above, operations of the electronic device 1000 have been briefly described. Hereinafter, components of the electronic device 1000 will be described in detail. Some of the components of the electronic device 1000, which will be described later, may be integrated to be provided as one component, and one component may be separated into two or more components to be provided.

The electronic device 1000 may communicate with an external electronic device 2000 through a network (e.g., a short-range wireless communication network or a long-range wireless communication network). According to some embodiments, the electronic device 1000 may include the processor 1110, the memory 1120, the input module 1130, the display module 1140, a power module 1150, an internal module 1160, and an external module 1170. According to some embodiments, in the electronic device 1000, at least one of the above-described components may be omitted, or one or more other components may be added. According to some embodiments, some components (e.g., the sensor module 1161, an antenna module 1162, and/or the sound output module 1163) among the above-described components may be integrated in another component (e.g., the display module 1140).

The processor 1110 may control at least another component (e.g., a hardware or software component) of the electronic device 1000, which is connected to the processor 1110, by executing software, and perform various processing or calculations. According to some embodiments, as at least a portion of the data processing and calculations, the processor 1110 may store, in a volatile memory 1121, a command or data, received from another component (e.g., the input module 1130, the sensor module 1161, or a communication module 1173), process the command or data, stored in the volatile memory 1121, and store result data in a nonvolatile memory 1122.

The processor 1110 may include a main processor 1111 and an auxiliary processor 1112. The main processor 1111 may include a central processing unit (CPU) 1111-1. The main processor 1111 may further include at least one of a graphic processing unit (GPU) 1111-2, a communication processor (CP), or an image signal processor (ISP). The main processor 1111 may further include a neural processing unit (NPU) 1111-3. The NPU 1111-3 is a processor specified for processing an artificial intelligence (AI) model, and the AI model may be generated through machine learning. The AI model may include a plurality of artificial neural network layers. An artificial neural network may be a deep neural network (DNN), a convolutional neural network (CNN), a recurrent neural network (RNN), a restricted boltzman machine (RBM), a deep belief network (DBN), a bidirectional recurrent deep neural network (BRDNN), a deep Q-networks, or one of two or more combinations thereof, but embodiments according to the present disclosure are not limited to the above-described example. The AI model may additionally or alternatively include a software structure, in addition to a hardware structure. At least two of the above-described processing units and the above-described processors may be implemented into one integrated component (e.g., a single chip), or be implemented as components (e.g., a plurality of chips) independent from each other.

The auxiliary processor 1112 may include a controller 1112-1. The controller 1112-1 may include an interface conversion circuit and a timing control circuit. According to some embodiments, the auxiliary processor 1112 may include the timing controller 140 or 140a shown in FIG. 1 or 4. The auxiliary processor 1112 may include the correction value generator 142 and the output data generator 144, which are shown in FIG. 5. At least some functions (or components) of the timing controller 140 or 140a may be included in the controller 1112-1, a data conversion circuit 1112-2, a gamma correction circuit 1112-3, a rendering circuit 1112-4, and the like.

The controller 1112-1 may receive an image signal from the main processor 1111, and convert a data format of the image signal to be suitable for interface specifications with the display module 1140, thereby outputting image data. The controller 1112-1 may output various control signals necessary for driving of the display module 1140.

The auxiliary processor 1112 may further include the data conversion circuit 1112-2, the gamma correction circuit 1112-3, the rendering circuit 1112-4, a touch control circuit 1112-5, and the like. The data conversion circuit 1112-2 may receive image data from the controller 1112-1, and compensate for the image data such that an image is displayed with a desired luminance according to a characteristic of the electronic device 1000 or a setting of the user or convert the image data for the purpose of reduction of power consumption, afterimage compensation, or the like.

The gamma correction circuit 1112-3 may convert image data, a gamma reference voltage, or the like such that an image displayed in the electronic device 1000 has a desired gamma characteristic. The gamma correction circuit 1112-3 may include the gamma generator 170 (i.e., the reference voltage generator 172 and the gamma voltage generator 174) shown in FIG. 6.

The rendering circuit 1112-4 may receive image data from the controller 1112-1, and render the image data by considering a pixel arrangement of the display panel 1141, and the like, applied to the electronic device 1000.

The touch control circuit 1112-5 may supply a touch signal to the input sensor 1161-2, and be supplied with a sensing signal from the input sensor 1161-2, corresponding to the touch signal.

At least one of the data conversion circuit 1112-2, the gamma correction circuit 1112-3, the rendering circuit 1112-4, or the touch control circuit 1112-5 may be integrated in another component (e.g., the main processor 1111 or the controller 1112-4). At least one of the data conversion circuit 1112-2, the gamma correction circuit 1112-3, or the rendering circuit 1112-4 may be integrated into a source driver 1143 which will be described later.

The memory 1120 may store various data used by at least one component (e.g., the processor 1110 or the sensor module 1161) of the electronic device 1000, and input or output data about a command associated with the various data. Also, various setting data corresponding to the setting of the user the memory 1120. The memory 1120 may include at least one of the volatile memory 1121 or the nonvolatile memory 1122.

The input module 1130 may receive a command or data to be used in a component (e.g., the processor 1110, the sensor module 1161, or the sound output module 1163) of the electronic device 1000 from an outside (e.g., the user or the external electronic device 2000) of the electronic device 1000.

The input module 1130 may include a first input module 1131 to which a command or data is input from the user and a second input module 1132 to which a command or data is input from the external electronic device 2000. The first input module 1131 may include a microphone, a mouse, a keyboard, a key (e.g., a button), or a pen (e.g., a passive pen or an active pen). The second input module 1132 may support a specified protocol capable of connecting the electronic device 1000 to the external electronic device 2000 by wired or wireless. According to some embodiments, the second input module 1132 may include a high definition multimedia interface (HDMI), a universal serial bus (USB) interface, an SD card interface, or an audio interface. The second input module 1132 may include a connector, e.g., an HDMI connector, a USB connector, an SD card connector, or an audio connector (e.g., a headphone connector), which can physically connect the electronic device 1000 to the external electronic device 2000.

The display module 1140 may visually provide information to the user. The display module 1140 may include the display panel 1141, a gate driver 1142, the source driver 1143, and a voltage generating circuit 1144. The display module 1140 may further include a window for protecting the display panel 1141, a chassis, and a bracket. The display module 1140 may include at least some components of the display device 100 shown in FIG. 1.

The display panel 1141 (or display) may include a liquid crystal display panel, an organic light emitting display panel, or an inorganic light emitting display panel, and the kind of the display panel 1141 is not particularly limited. The display panel 1141 may be of a rigid type or a flexible type in which the display panel 1141 is rollable or foldable. The display module 1140 may further include a supporter for supporting the display panel 1141, a bracket, a heat dissipation member, or the like. The display panel 1141 may include the display unit 110 shown in FIG. 1.

The gate driver 1142 is a driving chip, and may be mounted in the display panel 1141. Also, the gate driver 1142 may be integrated in the display panel 1141. According to some embodiments, the gate driver 1142 may include an Amorphous Silicon TFT Gate (ASG) driver circuit, a Low Temperature Polycrystalline Silicon (LTPS) TFT gate driver circuit, or an Oxide Semiconductor TFT Gate (OSG) driver circuit, which is embedded in the display panel 1141. The gate driver 1142 may receive a control signal from the controller 1112-1, and output scan signals to the display panel 1141 in response to the control signal. The gate driver 1142 may include the scan driver 120 shown in FIGS. 1 and 4.

The display module 1140 may further include an emission driver. The emission driver may output an emission control signal to the display panel 1141 in response to a control signal received from the controller 1112-1. The emission driver may be formed separately from the gate driver 1142, or be integrated in the gate driver 1142.

The source driver 1143 may receive a control signal from the controller 1112-1, and convert image data into an analog voltage (e.g., a data voltage) and then output data voltages to the display panel 1141 in response to the control signal. The source driver 1143 may include the data driver 130 shown in FIGS. 1 and 4.

The source driver 1143 may be integrated in another component (e.g., the controller 1112-1). Functions of the interface conversion circuit and the timing control circuit of the controller 1112-1, which are described above, may be integrated in the source driver 1143. The voltage generating circuit 1144 may output various voltages necessary for driving of the display panel 1141. According to some embodiments, the voltage generating circuit 1144 may include the power supply 150 shown in FIGS. 1 and 4.

According to some embodiments, the source driver 1143 may convert data corresponding to red (R), green (G), and blue (B), included in image data received from the processor 1110, into a red data signal, a green data signal, and a blue data signal, and provide the red data signal, the green data signal, and the blue data signal to a plurality of pixel columns included in the display panel 1141 during one horizontal period.

The power module 1150 may supply power to at least one component of the electronic device 1000. The power module 1150 may include the battery 160 shown in FIGS. 1 and 4, which charges a power voltage. The battery 160 may include a primary cell which is not rechargeable, a secondary cell which is rechargeable, or a fuel cell. The power module 1150 may include a power management integrated circuit (PMIC). The PMIC may supply an optimized power source to each of the above-described modules and modules which will be described later. The power module 1150 may include a wireless power transmission/reception member electrically connected to the battery. The wireless power transmission/reception member may include a plurality of coil-shaped antenna radiators. According to some embodiments, at least some components of the power module 1150 and the voltage generating circuit 1144 may be provided to be integrated into one. According to some embodiments, the voltage generating circuit 1144 may be included in the power module 1150.

The electronic device 1000 may further include the internal module 1160 and the external module 1170. The internal module 1160 may include the sensor module 1161, the antenna module 1162, and the sound output module 1163. The external module 1170 may include the camera module 1171, a light module 1172, and the communication module 1173.

The sensor module 1161 may sense an input caused by a body of the user or an input caused by a pen in the first input module, and generate an electrical signal or a data value, which corresponds to the input. The sensor module 1161 may include at least one of the fingerprint sensor 1161-1, the input sensor 1161-2, or a digitizer 1161-3.

The fingerprint sensor 1161-1 may generate a data value corresponding to a fingerprint of the user.

The input sensor 1161-2 may generate a data value corresponding to coordinate information of the input caused by the body of the user or the input caused by the pen. The input sensor 1161-2 may generate, as a data value, a capacitance variation caused by the input. The input sensor 1161-2 may sense an input caused by a passive pen, or transmit/receive data to/from an active pen.

The input sensor 1161-2 may measure a biometric signal such as pressure, moisture or body fat. According to some embodiments, in case that the user does not move for a constant time while a body part of the user is in contact with a sensor layer or a sensing panel, the input sensor 1161-2 may output information which the user wants to the display module 1140 by sensing a biometric signal, based on a change in electric field, caused by the body part.

The digitizer 1161-3 may generate a data value corresponding to the coordinate information of the input caused by the pen. The digitizer 1161-3 may generate, as a data value, an electromagnetic variation caused by the input. The digitizer 1161-3 may sense an input caused by the passive pend, or transmit/receive data to/from the active pen.

At least one of the fingerprint sensor 1161-1, the input sensor 1161-2, or the digitizer 1161-3 may be implemented as a sensor layer formed on the display panel 1141 through a continuous process. At least one of the fingerprint sensor 1161-1, the input sensor 1161-2, or the digitizer 1161-3 may be located at an upper side of the display panel 1141, and any one, e.g., the digitizer 1161-3 among the fingerprint sensor 1161-1, the input sensor 1161-2, and the digitizer 1161-3 may be located at a lower side of the display panel 1141.

At least two of the fingerprint sensor 1161-1, the input sensor 1161-2, and the digitizer 1161-3 may be formed to be integrated into one sensing panel through a same process. In case that at least two of the fingerprint sensor 1161-1, the input sensor 1161-2, and the digitizer 1161-3 are integrated into one sensing panel, the sensing panel may be located between the display panel 1141 and the window located at an upper side of the display panel 1141. According to some embodiments, the sensing panel may be located on the window, and the position of the sensing panel is not particularly limited.

At least one of fingerprint sensor 1161-1, the input sensor 1161-2, or the digitizer 1161-3 may be built in the display panel 1141. That is, at least one of fingerprint sensor 1161-1, the input sensor 1161-2, or the digitizer 1161-3 may be simultaneously formed through a process of forming elements (e.g., a light emitting element, a transistor, and the like) included in the display panel 1141.

Besides, the sensor module 1161 may generate an electrical signal or a data value, which corresponds to an internal state or an external state of the electronic device 1000. The sensor module 1161 may further include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The antenna module 1162 may include one or more antennas for transmitting a signal or power to the outside or receiving a signal or power from the outside. According to some embodiments, the communication module 1173 may transmit a signal to the external electronic device or receive a signal from the external electronic device through an antenna suitable for a communication scheme. An antenna pattern of the antenna module 1162 may be integrated in one component (e.g., the display panel 1141) of the display module 1140, the input sensor 1161-2, or the like.

The sound output module 1163 is a device for outputting a sound signal to the outside of the electronic device 1000, and include, for example, a speaker used for a general purpose such as multimedia playback or transcription playback and a receiver used for only call reception. According to some embodiments, the receiver may be integrally formed with the speaker or be formed separately from the speaker. A sound output pattern of the sound output module 1163 may be integrated in the display module 1140.

The camera module 1171 may photograph a still image and a moving image. According to some embodiments, the camera module 1171 may include one or more lenses, an image sensor, or an image signal processor. The camera module 1171 may further include an infrared camera capable of measuring existence of the user, a position of the user, eyes of the user, or the like.

The light module 1172 may provide light. The light module 1172 may include a light emitting diode or a xenon lamp. The light module 1172 may operate in linkage with the camera module 1171 or operate independently from the camera module 1171.

The communication module 1173 may establish a wired or wireless communication channel between the electronic device 1000 and the external electronic device 2000, and support communication performance through the established communication channel. The communication module may include any one or all of a wireless communication module such as a cellular communication module, a short-range wireless communication module, or a global navigation satellite system (GNSS) communication module, and a wired communication module such as a local area network (LAN) communication module or a power line communication (PLC) module. The communication module 1173 may communicate with the external electronic device 2000 through a short-range communication network such as Bluetooth™, wireless-fidelity (WiFi) direct, or infrared data association (IrDA), or a long-range communication network such as a cellular network, Internet, or a computer network (e.g., LAN or wide area network (WAN)). The above-described several kinds of communication modules may be implemented into one chip or be respectively implemented as separate chips.

The input module 1130, the sensor module 1161, the camera module 1171, and the like may be used to control an operation of the display module 1140 in linkage with the processor 1110.

The processor 1110 may output a command or data to the display module 1140, the sound output module 1163, the camera module 1171, or the light module 1172, based on input data received from the input module 1130. For example, the processor 1110 may generate image data, corresponding to input data applied through a mouse, an active pen, or the like, and output the image data to the display module 1140. Alternatively, the processor 1110 may generate command data, corresponding to the input data, and output the command data to the camera module 1171 or the light module 1172. In case that no input data is received from the input module 1130, the processor 1110 may change the operation mode of the electronic device 1000 to a low power mode or a sleep mode, thereby reducing power consumed in the electronic device 1000.

The processor 1110 may output a command or data to the display module 1140, the sound output module 1163, the camera module 1171, or the light module 1172, based on sensing data received from the sensor module 1161. For example, the processor 1110 may compare authentication data applied by the fingerprint sensor 1161-1 with authentication data stored in the memory 1120, and then execute an application according to a comparison result. The processor 1110 may execute a command or output corresponding image data to the display module 1140, based on sensing data sensed by the input sensor 1161-2 or the digitizer 1161-3. In case that a temperature sensor is included in the sensor module 1161, the processor 1110 may receive temperature data about a temperature measured from the sensor module 1161, and further perform luminance correction on image data, based on the temperature data.

The processor 1110 may receive measurement data about existence of the user, a position of the user, eyes of the user, or the like from the camera module 1171. The processor 1110 may further perform luminance correction on image data, based on the measurement data. For example, the processor 1110 which decides the existence of the user through an input from the camera module 1171 may output image data of which luminance is corrected to the display module 1140 through the data conversion circuit 1112-2 or the gamma correction circuit 1112-3.

At least some of the above-described components may be connected to each other and communicate signals (e.g., commands or data) therebetween through an inter-peripheral communication scheme, e.g., a bus, a general purpose input/output (GPIO), a serial peripheral interface (SPI), a mobile industry processor interface (MIPI), or an ultra path interconnect (UPI) link. The processor 1110 may communicate with the display module 1140 through an appointed interface, and use any one of the above-described communication schemes. However, embodiments according to the present disclosure are not limited to the above-described communication schemes.

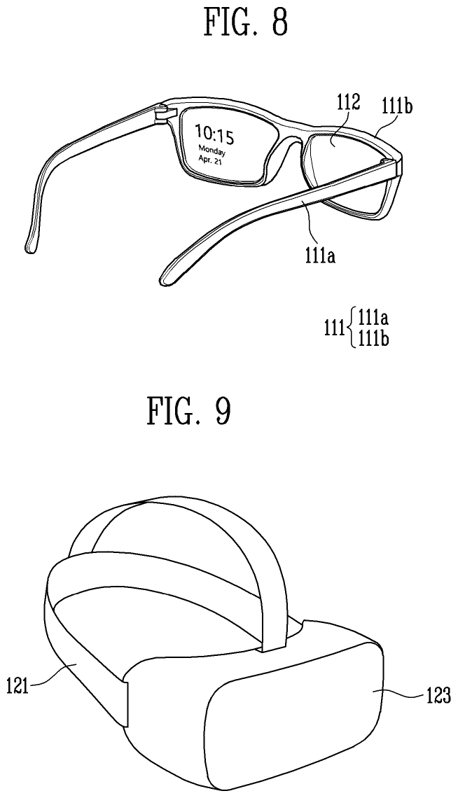

FIGS. 8 to 11 are views illustrating electronic devices according to some embodiments of the present disclosure.

Referring to FIG. 8, the display device 100 according to some embodiments of the present disclosure may be applied to smart glasses. The smart glasses include a frame 111 and a lens part 112. The smart glasses are a wearable electronic device which can be worn on the face of a user, and may have a structure in which a portion of the frame 111 is folded or unfolded. For example, the smart glasses may be a wearable device for Augmented Reality (AR).

The frame 111 may include a housing 111b supporting the lens part 112 and a leg part 111a for allowing the user to wear the smart glasses. The leg part 111a may be connected to the housing 111b by a hinge to be folded or unfolded.

A battery, a touch pad, a microphone, and/or a camera may be built in the frame 111. In addition, a projector for outputting light and/or a processor for controlling a light signal may be built in the frame 111.

The lens part 112 may be an optical member which allows light to be transmitted therethrough or allows light to be reflected thereby. The lens part 112 may include glass and/or transparent synthetic resin.

The display device 100 according to some embodiments of the present disclosure may be applied to the lens part 112. According to some embodiments, the user may recognize an image displayed by a light signal transmitted from the projector of the frame 111 through the lens part 112. For example, the user may recognize information including time, data, and the like, which are displayed on the lens part 112.

Referring to FIG. 9, the display device 100 according to some embodiments of the present disclosure may be applied to a Head Mounted Display (HMD). The HMD may include a head mounted band 121 and a display accommodating case 123. For example, the HMD is a wearable electronic device which can be worn on the head of a user.

The head mounted band 121 may be connected to the display accommodating case 123, to fix the display accommodating case 123. The head mounted band 121 may include a horizontal band and a vertical band to fix the HMD to the head of the user. The horizontal band may surround a side portion of the head of the user, and the vertical band may surround a top portion of the head of the user. However, embodiments according to the present disclosure are not necessarily limited thereto, and the head mounted band 121 may be implemented in the shape of a glasses frame or a helmet.

The display accommodating case 123 accommodates the display device, and may include at least one lens. The at least one lens may display an image to the user. For example, the display device 100 according to some embodiments of the present disclosure may be applied to a left-eye lens and a right-eye lens, which are implemented in the display accommodating case 123.

Referring to FIG. 10, the display device 100 according to some embodiments of the present disclosure may be applied to a smart watch. The smart watch may include a display part 131 and a strap part 133. The smart watch is a wearable electronic device, and may be mounted on a wrist of a user. The display device 100 according to some embodiments of the present disclosure may be applied to the display part 131. For example, the display part 131 may provide image data including information such as time and data.

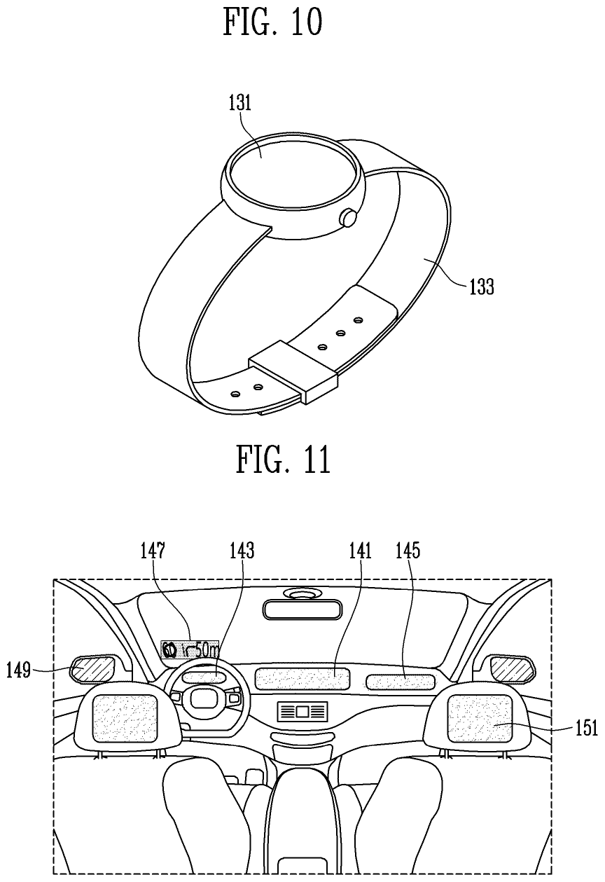

Referring to FIG. 11, the display device 100 according to some embodiments of the present disclosure may be applied to an automotive display. According to some embodiments, the automotive display may mean an electronic device provided at the inside/outside of a vehicle to provide image data.

For example, the display device 100 according to some embodiments of the present disclosure may be applied to at least one of an infortainment panel 141, a cluster 143, a co-driver display 145, a head-up display 147, a side mirror display 149, or a rear seat display 151, which are provided in the vehicle.

In the display device and the method of driving the same, and the electronic device according to some embodiments of the present disclosure, a relatively high driving power source is supplied to a blue pixel, and a relatively low driving power source is supplied to a red pixel and a green pixel. Thus, power consumed in the red pixel and the green pixel can be relatively reduced.

Aspects of some embodiments have been disclosed herein, and although specific terms are employed, they are used and are to be interpreted in a generic and descriptive sense only and not for purpose of limitation. In some instances, as would be apparent to one of ordinary skill in the art as of the filing of the application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of embodiments according to the present disclosure as set forth in the following claims, and their equivalents.

What is claimed is:

1. A display device comprising:
a battery;
a voltage generator configured to generate a first driving power source, corresponding to an input power source supplied from the battery; and
pixels connected to scan lines and data lines,
wherein the pixels include:
a first pixel configured to emit light of a first color, corresponding to the first driving power source; and
a second pixel configured to emit light of a second color, corresponding to a second driving power source supplied from the battery.

2. The display device of claim 1, wherein the second driving power source and the input power source have a same power source.

3. The display device of claim 1, wherein the second driving power source has a lower voltage than the first driving power source.

4. The display device of claim 3, wherein the first color is blue and the second color is red.

5. The display device of claim 4, wherein the pixels further include a third pixel configured to emit light of a third color, corresponding to the second driving power source, and
wherein the third color is green.

6. The display device of claim 1, further comprising:
a scan driver configured to drive the scan lines;
a data driver configured to drive the data lines; and
a timing controller configured to control the scan driver and the data driver.

7. The display device of claim 6, wherein each of the pixels includes:
a light emitting element configured to emit light of the first color or the second color; and
a driving transistor configured to supply a driving current to the light emitting element from the first driving power source or the second driving power source.

8. The display device of claim 7, wherein the driving transistor is a P-type transistor.

9. The display device of claim 8, wherein the timing controller includes:
a correction value generator configured to receive the second driving power source, and to generate a correction value, corresponding to a voltage of the second driving power source; and
an output data generator configured to generate corrected output data by reflecting the correction value on input data.

10. The display device of claim 9, wherein the corrected output data corresponds to the second pixel.

11. The display device of claim 8, further comprising:
a reference voltage generator configured to receive the second driving power source, and to generate a first gamma reference voltage and a second gamma reference voltage; and
a gamma voltage generator configured to generate first gamma voltages corresponding to the first pixel and second gamma voltages corresponding to the second pixel, corresponding to the first gamma reference voltage and the second gamma reference voltage,
wherein the second gamma reference voltage is controlled corresponding to a voltage of the second driving power source.

12. The display device of claim 11, wherein the gamma voltage generator includes:
a first gamma voltage generator configured to generate the first gamma voltages, corresponding to the first gamma reference voltage; and
a second gamma voltage generator configured to generate the second gamma voltages, corresponding to the second gamma reference voltage.

13. A method of driving a display device, the method comprising:
allowing first pixels to emit light of a first color, corresponding to a driving current supplied from a first driving power source; and
allowing second pixels to emit light of a second color, corresponding to a driving current supplied from a second driving power source,
wherein the first color is blue, the second color is red, and the second driving power source has a lower voltage than the first driving power source.

14. The method of claim 13, further comprising:
generating the first driving power source by boosting an input voltage supplied from a battery; and
supplying the first driving power source to the first pixels.

15. The method of claim 14, wherein the second driving power source is supplied to the second pixels from the battery.

16. The method of claim 15, wherein the second driving power source is the input voltage.

17. The method of claim 13, further comprising:
generating a correction value, corresponding to a voltage of the second driving power source; and
generating output data by reflecting the correction value on input data to be supplied to the second pixels.

18. The method of claim 17, wherein the correction value is set such that light with a luminance corresponding to a grayscale is generated in the second pixels, corresponding to a voltage of the second driving power source.

19. The method of claim 13, further comprising:
controlling gamma voltages, corresponding to the second driving power source; and
generating a data signal to be supplied to the second pixels, using the gamma voltages.

20. An electronic device comprising:
a main processor;
a controller configured to receive an image signal from the main processor, and output image data by converting a data format of the image signal;
a memory configured to store data processed from the main processor;
a battery;
a voltage generator configured to generate a first driving power source, corresponding to an input power source supplied from the battery; and
a display panel including pixels connected to scan lines and data lines,
wherein the pixels include:
a first pixel configured to emit light of a first color, corresponding to the first driving power source; and
a second pixel configured to emit light of a second color, corresponding to a second driving power source which is supplied from the battery and has a relatively low voltage as compared with the first driving power source.
